(19) United States
(12) Patent Application Publication
(10) Pub. No.: US 2005/0222979 A1
(43) Pub. Date: Oct. 6, 2005

(54) Querying method information

(76) Inventors: Gansha Wu, Beijing (CN); Guei-Yuan Lueh, San Jose, CA (US)

Correspondence Address: TROP PRUNER & HU, PC, 8554 KATY FREEWAY, SUITE 100, HOUSTON, TX, 77024, US

(21) Appl. No.: 10/814,758

(22) Filed: Mar. 31, 2004

(51) Int. Cl. G06F 7/00

(52) U.S. Cl. 707/3

(57) ABSTRACT

A technique includes querying method information in execution environments for programs written for virtual machines. This technique limits the searching scope within a relatively smaller region of the queried instruction pointer (IP) or code address and relieves the management overhead of a method lookup table, with garbage collector facilitation. In one embodiment, a system receives a code address and queries method metadata for the code address by limiting the search scope within a local memory sub-region of the code address.

### BACKGROUND

This invention relates generally to execution environments for programs written for virtual machines.

Unlike other programming languages, some programming languages, such as JAVA®—a simple object oriented language, are executable on a virtual machine. In this manner, a “virtual machine” is an abstract specification of a processor so that special machine code (called “bytecodes”) may be used to develop programs for execution on the virtual machine. Various emulation techniques are used to implement the abstract processor specification including, but not restricted to, interpretation of the bytecodes or translation of the bytecodes into equivalent instruction sequences for an actual processor.

In an object-oriented environment, everything is an object and is manipulated as an object. Objects communicate with one another by sending and receiving messages. When an object receives a message, the object responds by executing a method, that is, a program stored within the object determines how it processes the message. The method has method information or metadata associated therewith.

For modem programming systems, a common task is to query method metadata given a code address (or instruction pointer, IP). A representative usage is identifying method information for a specific frame during stack unwinding; another typical usage is locating method symbols by a sampling-based profiler. The efficiency of the query implementation is ideally essential to the system performance, especially for managed runtime environments where the lookup time is part of run time. Conventional query implementation may employ a data structure, e.g., method lookup table, to save the starting and ending addresses of each method after the compiler generates its code. The data structure may be a linear sorted array that reduces search time. This mechanism works well for traditional static or runtime environments on desktops and servers.

However, this mechanism faces new challenges for emerging mobile platforms for the following reasons. The size of method lookup table is proportional to the number of compiled methods, which is a burden in terms of search and maintenance for small footprint systems. The runtime searching within the table is not as efficient in mobile systems as that on desktop and server environments due to limited computing capability and memory system with lower performance. The new trend of allocating and recycling code in managed space introduces a considerable complexity to maintain [start_addr, end_addr] tuples. The starting and ending addresses for a specific method may be changed or even invalidated if garbage collector (GC) reclaims the method's code.

Thus, there is a continuing need for better ways to query method information in execution environments for programs written for virtual machines.

### BRIEF DESCRIPTION OF THE DRAWINGS

FIG. 1 is a schematic depiction of a runtime system platform consistent with one embodiment of the present invention;

FIG. 2 is a flow chart showing querying method information according to one embodiment of the present invention;

FIG. 3 is a schematic depiction of a memory block layout according to one embodiment of the present invention;

FIG. 4 is a routine to query block information given an arbitrary code address in accordance with one embodiment of the present invention;

FIG. 5 is a routine showing implementation of querying method information according to one embodiment of the present invention;

FIG. 6 is a schematic depiction of a memory block layout with local allocation bits in accordance with one embodiment of the present invention;

FIG. 7 shows pseudo code for allocation bits based query implementation for the memory block layout of FIG. 6 according to one embodiment of the present invention; and

FIG. 8 is a schematic depiction of a processor-based system with the operating system platform of FIG. 1 in accordance with one embodiment of the present invention.

### DETAILED DESCRIPTION

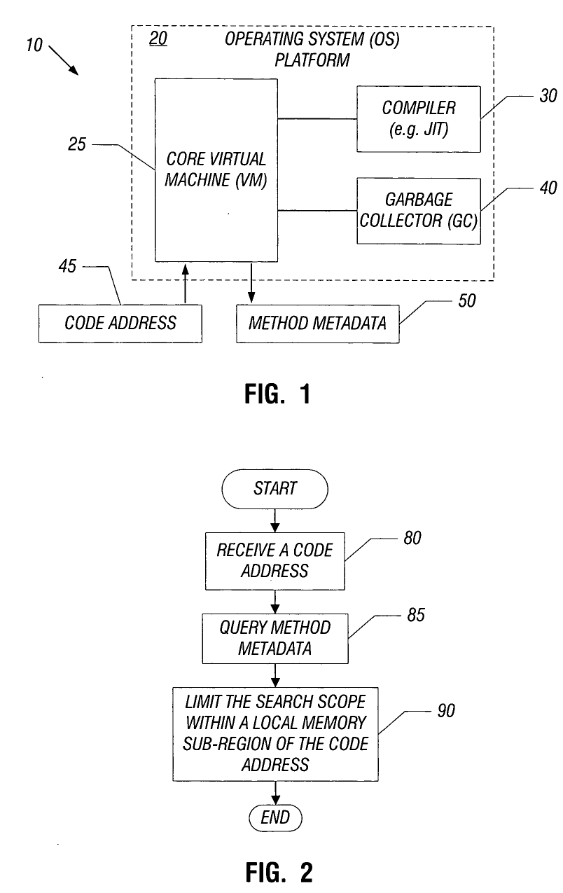

Referring to FIG. 1, a system 10 according to one embodiment of the invention is shown. The system 10 includes an operating system (OS) platform 20 that comprises a core virtual machine (VM) 25, a compiler 30 and a garbage collector (GC) module 40. In one embodiment, system 10 may be any processor-based system. Examples of the system 10 include a personal computer (PC), a hand held device, a cell phone, a personal digital assistant, and a wireless device. Those of ordinary skill in the art will appreciate that system 10 may also include other components, not shown in FIG. 1; only those parts necessary to describe an embodiment of the invention in an enabling manner are provided.

In one embodiment, using the garbage collector (GC) module 40, the system 10 may limit the searching scope for the method information or metadata 50 within a local memory sub-region of the queried instruction pointer (IP) or code address 45 and relieve the management overhead of a method lookup table. The GC module 40 may partition the managed heap into local memory sub-regions. Each of the local memory sub-regions include continuous memory space size of which depends upon a particular implementation. For example, in the system 10, the core virtual machine 25 may query the method information or metadata 50 with the assistance of the garbage collector module 40. The system 10 partitions the global method lookup table into smaller and distributed versions, associated with a local memory sub-region. The global method lookup table includes the information for all the methods that have been compiled in the system-wide scope. A distributed method lookup table is a portion of the global method lookup table that is associated with a particular local memory sub-region (contains the information for the methods whose code are stared in this sub-region).

Consistent with one embodiment of the present invention, a JAVA® virtual machine (JVM) may be provided to interpretatively execute a high-level, byte-encoded representation of a program in a dynamic runtime environment. In addition, the garbage collector 40 shown in FIG. 1 may provide automatic management of the address space by seeking out inaccessible regions of that space (i.e., no live address point to them) and returning them to the free memory pool. In the context of this invention, The GC module 40 may also manage the space of compiled code. The just-in-time compiler 30 shown in FIG. 1 may be used at runtime or install time to translate the bytecode representation of the program into native machine instructions, which run much faster than interpreted code.

While the core virtual machine 25 is responsible for the overall coordination of the activities of the operating system (OS) platform 20, the operating system platform 20 may be a high-performance managed runtime environment (MRTE). The compiler 30 may be a just-in-time (JIT) compiler responsible for compiling bytecodes into native managed code, and for providing information about stack frames that can be used to do root-set enumeration, exception propagation, and security checks.

The main responsibility of the garbage collector module 40 may be to allocate space for objects, manage the heap, and perform garbage collection. A garbage collector interface may define how the garbage collector module 40 interacts with the core virtual machine 25 and the just-in-time compilers (JITs). The managed runtime environment may feature exact generational garbage collection, fast thread synchronization, and multiple just-in-time compilers, including highly optimizing JITs.

The core virtual machine 25 may further be responsible for class loading: it stores information about every class, field, and method loaded. The class data structure may include the virtual-method table (vtable) for the class (which is shared by all instances of that class), attributes of the class (public, final, abstract, the element type for an array class, etc.), information about inner classes, references to static initializers, and references to finalizers. The operating system platform 20 may allow many JITs to coexist within it. Each JIT may interact with the core virtual machine 25 through the JIT interface, providing an implementation of the JIT side of this interface.

In operation, conventionally when the core virtual machine 25 loads a class, new and overridden methods are not immediately compiled. Instead, the core virtual machine 25 initializes the vtable entry for each of these methods to point to a small custom stub that causes the method to be compiled upon its first invocation. After the compiler 30, such as a JIT compiler, compiles the method, the core virtual machine 25 iterates over all vtables containing an entry for that method, and it replaces the pointer to the original stub with a pointer to the newly compiled code.

Referring to FIG. 2, at block 80, the core virtual machine 25 may receive a code address 45. At block 85, the system 10 may query the method metadata 50. At block 90, the core virtual machine 25 may limit the search scope within a local memory sub-region of the code address 45. Consistent with one embodiment of the present invention, the core virtual machine 25 may maintain a limited set of methods for which codes are allocated within the local memory sub-region for each smaller and distributed version of the global method lookup table.

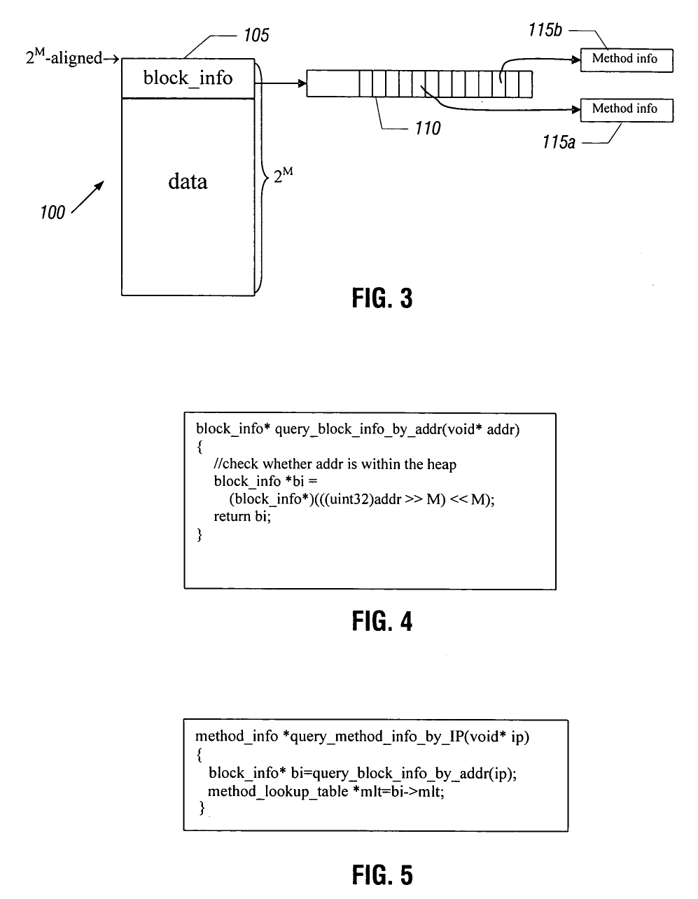

FIG. 3 shows a schematic depiction of the layout of a memory sub-region, namely block 100, according to one embodiment of the present invention. For example, the memory block 100 may be a continuous space with size of 2^{M}, and as an embodiment, it may have a layout shown in FIG. 3 where M is a reasonable number that determines the block's size, e.g., a M of 16 indicates the size of the block is 2¹⁶ or 64 K bytes. The depicted embodiment places block information (block_info) 105 at the beginning of the block, whose address is aligned to 2^{M}. In accordance with one embodiment, the memory block 100 presents a direct way to get the block_info 105 data from an arbitrary address via some bit/logic operation(s), truncating the tailing M bits. The tailing M bits are the offset to the block starting address.

More specifically, each distributed lookup table 110 maintains only a limited set of methods 115 including the methods 115a and 115b, whose codes are allocated within the local memory sub-region. The global method lookup table doesn't exist anymore, but is divided into the distributed lookup tables 110 with 1:1 mapping to local memory sub-region. An appropriate division policy may substantially scale down the management complexity (e.g., inserting, removing, and searching for entries) for an individual lookup table. These distributed lookup tables, such as the distributed lookup table 110 unlike conventional designs, are no longer Execution Engine (EE) data structures. Instead, the manipulation work is under the direct control of the GC module 40 that has full knowledge of whether some codes are relocated or recycled in a specified local sub-region.

FIG. 4 is a routine to query block information given an arbitrary code address in accordance with one embodiment of the present invention. Specifically, FIG. 4 illustrates a two-shift-operation means for getting block_info 105, while on some other architectures, a single bit- and operation may work. The block_info 105 contains a pointer to a distributed method lookup table 110 (or variants) dedicated to the specific block, and table entries represent code objects created in this memory block 100.

FIG. 5 is a routine showing implementation of querying method information according to one embodiment of the present invention. In one embodiment, the GC module 40 assumes the responsibility to maintain the distributed lookup tables 110. The scale of these local tables may be smaller than a conventional global table by orders of magnitude. Correspondingly, the complexity and overhead of operations like insertion and lookup may be much lower, in some embodiments. Furthermore, more merits may be inherited from the use of GC module 40.

In most cases, the block-level allocation goes sequentially, i.e., the compiled code objects are often laid out as in an allocation order. The allocation order is the time order in which the high-level applications allocate objects. The spatial order of these objects comply with the time order, e.g., if object A is allocated before B, the address of A is smaller than B. Therefore, the “insert” operation regresses to a simpler “append” operation (without memory moving), given that the table's “sorted” property is retained naturally. The GC module 40 automatically re-constructs the local tables instantly after it finishes recycling or moving objects, and the reconstruction may be trivial (with respect to the massive load during the GC module 40 pause time) and internal for the GC module 40 with the extra complexity of virtual machine-garbage collector (VM-GC) interfaces exempted.

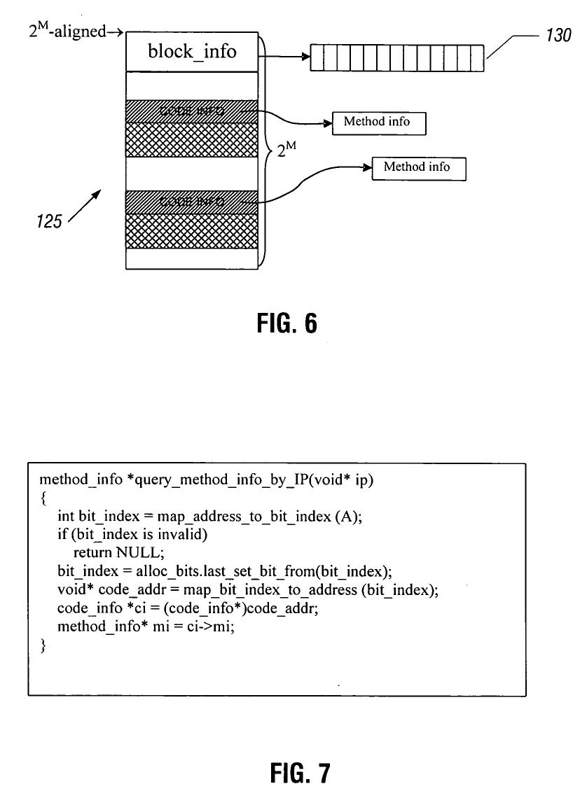

FIG. 6 is a schematic depiction of a memory block 125 layout with local allocation bits 130 for the memory block 125 shown in accordance with one embodiment of the present invention. Many garbage collectors (GCs) maintain a chunk of plain bits, namely “allocation bits,” with each of the bits mapped to a legal object address in heap space. When an object is allocated as some address, the related allocation bit is set to indicate the presence of this live object; when the object is reclaimed (dead), the related allocation bit is reset. Conventionally, the GC module 40 utilizes allocation bits to clarify whether or not an integer value coincidentally refers to or exists inside a living object. For example, the internal structure and data of a code object may be hidden from the outside world (“encapsulated”) behind a limited set of well-defined interfaces. Code objects may be distinguished from one another through unique object identifiers, usually implemented as abstract pointers.

In the context of this embodiment of the present invention, the allocation bits 130 identify the code object that encloses an arbitrary code address. For those GCs without native support allocation bits, a small dedicated bits segment may be deployed to store allocation bits for code space (not the whole heap space). If each N-byte aligned address in code space is a legal object address, and the size of code space is S, then allocation bits table may occupy (S/(N*8) ) bytes. In most cases, the space cost is acceptable even for memory-constrained systems. Still in accordance with one embodiment, the allocation bits may be partitioned into small subsets for individual blocks, due to the locality concern.

While the FIG. 6 shows the memory block 125 layout with external local allocation bits 130, the block level allocation bits 130 are not necessarily external to the memory block 125. For another embodiment, the block level allocation bits 130 may just be located at the block header. The method_info for a code may be extracted from the code_info data structure, which stays at the beginning of the code. Each time the GC module 40 allocates a code object at address A, an allocation bit is set correspondingly as follows:
bit_index=map address_to_bit_index(A);
alloc_bit_table.set(bit_index);

At the beginning of the code, the GC module 40 places a code_info data structure, which in turn stores the pointer to method_info. When the GC module 40 reclaims the code object at address A, the relevant allocation bit is reset:
bit_index=map_address_to_bit_index(A);
alloc_bit_table.unset(bit_index);

Similarly, the relocation of a code object may lead to a pair of operations, that is, the bit for the old address is unset and then a new bit is set.

FIG. 7 shows pseudo code for allocation bits based query implementation for the memory block 125 layout of FIG. 6 according to one embodiment of the present invention. Each allocation bit may indicate the presence of a method lookup table entry, and the content of the entry appears at the front of the code object. The GC module 40 may provide ease of management and lookup locality together in an ideal manner.

In this manner, allocation bits may provide a fast and cache friendly way to locating a code object, given an instruction pointer (IP) pointing into some internal address of the code. The allocation bits based query implementation for the memory block 125 may work as follows, in one embodiment. First, allocation bits map the instruction pointer to a bit index. Then system 10 searches allocation bits backwardly starting from the bit index, until a set bit is encountered. This bit corresponds to the starting address of the enclosing code. Thereafter, the method_info for the code may be easily extracted from the code_info data structure at the beginning of the code.

Though the implementation of allocation bits is subject to flexible design considerations, the operation of searching for last set bit, alloc_bits.last_set_bit_from( ), is generally fast in that the underhood bit iterating mechanism may be lightweight for most languages and architectures. The underhood bit iterating mechanism entails the task to find an adjacent allocation bit. For example, if the binary representation “1” indicates a bit is set, a byte (or even a word) is always checked first to determine whether it equals to “0.” If so, all bits for the byte (or word) are obviously unset and skipped. The operation is also more cache friendly: the allocation bits are often very compact and deployed at the block level, so that bit iterating often occurs in relatively small scope that is easier for the cache to tolerate. Given the fact that code objects are usually much larger than normal object populations, the bit iterating solution tends to be more efficient than other means like cookie-instructed striding in code space.

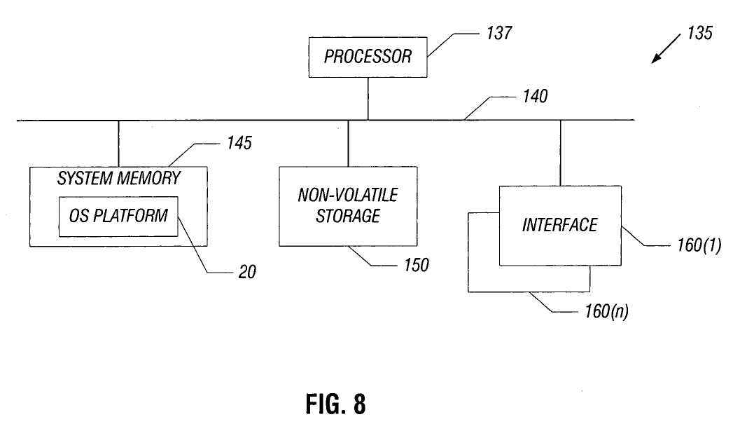

FIG. 8 is a schematic depiction of a processor-based system 135 with the operating system platform 20 of FIG. 1 in accordance with one embodiment of the present invention. A processor 137 may be coupled to a system memory 145 storing the OS platform 20 via a system bus 140. The system bus 140 may couple to a non-volatile storage 150. Interfaces 160 (1) through 160 (n) may couple to the system bus 140 in accordance with one embodiment of the present invention. The interface 160 (1) may be a bridge or another bus based on the processor-based system 135 architecture.

For example, depending upon the OS platform 20, the processor-based system 135 may be a mobile or a wireless device. In this manner, the processor-based system 135 uses a technique that includes querying method information in execution environments for programs written for virtual machines. This technique may limit the searching scope for the method metadata 50 within a relatively small region of the queried instruction pointer or code address 45 and may relieve the management overhead of method lookup table, with garbage collector facilitation provided by the garbage collector module 40 shown in FIG. 1. In one embodiment, the non-volatile storage 150 may store instructions to use the above-described technique. The processor 137 may execute at least some of the instructions to provide the core virtual machine 25 to receive the code address 45 and query method metadata 50 for the code address 45 by limiting the search scope within a local memory sub-region of said code address.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
receiving a code address; and
querying method metadata for said code address by limiting a search scope within a local memory sub-region of said code address.

2. The method of claim 1, further comprising:
partitioning a global method lookup table into smaller and distributed versions for said local memory sub-region.

3. The method of claim 2, further comprising:
maintaining a limited set of methods for which codes are allocated within said local memory sub-region for said smaller and distributed version of the global method lookup table.

4. The method of claim 1, further comprising:
providing a continuous space to a memory block to locate method metadata; and
placing block information regarding said memory block at a beginning of continuous space.

5. The method of claim 4, further comprising:
providing a pointer to a distributed method lookup table from said block information.

6. The method of claim 5, wherein table entries of said distributed method lookup table represent code objects created in said memory block.

7. The method of claim 5, further comprising:
providing a virtual machine; and
providing a garbage collector for said virtual machine to maintain said distributed method lookup table.

8. The method of claim 1, further comprising:
maintaining allocation bits with each bit mapped to a legal object address in heap space; and
using said allocation bits to identify a code object that encloses an arbitrary code address.

9. The method of claim 8, further comprising:
partitioning the allocation bits into subsets for individual memory blocks.

10. The method of claim 9, further comprising:
receiving an instruction pointer pointing into some internal address of the code; and
locating said code object based on said instruction pointer.

11. A system comprising:
a non-volatile storage storing instructions; and
a processor to execute at least some of the instructions to provide a virtual machine to receive a code address and query method metadata for said code address by limiting a search scope within a local memory sub-region of said code address.

12. The system of claim 11, wherein said virtual machine to partition a global method lookup table into smaller and distributed versions for said local memory sub-region.

13. The system of claim 12, wherein said virtual machine to maintain a limited set of methods for which codes are allocated within said local memory sub-region for each said smaller and distributed version of the global method lookup table.

14. The system of claim 11, further comprising:
a memory block with a continuous space with size of 2^{M} to locate method metadata and place information regarding said memory block at the beginning of the continuous space.

15. The system of claim 14, further comprising:
a pointer to a distributed lookup table from said block information.

16. The system of claim 15, wherein table entries of said distributed method lookup table represent code objects created in said memory block.

17. The system of claim 15, further comprising:
a garbage collector for said virtual machine to maintain said distributed method lookup table.

18. The system of claim 11, wherein said virtual machine to maintain allocation bits with each bit mapped to a legal object address in heap space and use said allocation bits to identify a code object that encloses an arbitrary code address.

19. The system of claim 18, wherein said virtual machine to partition the allocation bits into subsets for individual memory blocks.

20. The system of claim 19, wherein said virtual machine to receive an instruction pointer pointing into some internal address of the code and locate said code object based on said instruction pointer.

21. An article comprising a machine accessible medium storing instructions that, when executed cause a processor-based system to:
receive a code address; and
query method metadata for said code address by limiting the search scope within a local memory sub-region of said code address.

22. The article of claim 21, comprising a medium storing instructions that, when executed cause a processor-based system to:
partition a global method lookup table into smaller and distributed versions for said local memory sub-region.

23. The article of claim 22, comprising a medium storing instructions that, when executed cause a processor-based system to:
maintain a limited set of methods for which codes are allocated within said local memory sub-region for said smaller and distributed version of the global method lookup table.

24. The article of claim 21, comprising a medium storing instructions that, when executed cause a processor-based system to:
provide a continuous space to a memory block to locate method metadata placing block information regarding said memory block at a beginning of the continuous space.

25. The article of claim 24, comprising a medium storing instructions that, when executed cause a processor-based system to:
provide a pointer to a distributed method lookup table from said block information.

26. The article of claim 25, comprising a medium storing instructions that, when executed cause a processor-based system to:
represent code objects created in said memory block as table entries of said distributed method lookup table.

27. The article of claim 25, comprising a medium storing instructions that, when executed cause a processor-based system to:
provide a virtual machine; and
provide a garbage collector for said virtual machine to maintain said distributed method lookup table.

28. The article of claim 21, comprising a medium storing instructions that, when executed cause a processor-based system to:
maintain allocation bits with each bit mapped to a legal object address in heap space; and
use said allocation bits to identify a code object that encloses an arbitrary code address.

29. The article of claim 28, comprising a medium storing instructions that, when executed cause a processor-based system to:
partition the allocation bits into subsets for individual memory blocks.

30. The article of claim 29, comprising a medium storing instructions that, when executed cause a processor-based system to:
receive an instruction pointer pointing into some internal address of the code; and
locate said code object based on said instruction pointer.
